(19) United States
(12) Patent Application Publication
(10) Pub. No.: US 2014/0293969 A1
(43) Pub. Date: Oct. 2, 2014

(54) UTILIZATION OF REDUNDANT INDICATION FIELD

(71) Applicant: MEDIATEK INC., Hsin-Chu (TW)

(72) Inventors: Jeng-Yi Tsai, Hsinchu City (TW); Ho-Chi Huang, Hsinchu County (TW)

(73) Assignee: MEDIATEK INC., Hsin-Chu (TW)

(21) Appl. No.: 14/135,527

(22) Filed: Dec. 19, 2013

Related U.S. Application Data
(60) Provisional application No. 61/807,060, filed on Apr. 1, 2013.

(51) Int. Cl. H04W 72/08; H04L 5/00

(52) U.S. Cl. CPC H04W 72/085; H04L 5/0085
USPC 370/336

(57) ABSTRACT

A method of utilizing same indication fields of time slots for different purposes includes: transmitting an indication signal in an indication field of at least one first time slot on a dedicated physical channel (DPCH); and transmitting at least one known symbol in an indication field of at least one second time slot on the DPCH, wherein the known symbol is arranged for estimating channel characteristics.

### CROSS REFERENCE TO RELATED APPLICATIONS

This application claims the benefit of U.S. provisional application No. 61/807,060, filed on Apr. 1, 2013 and incorporated herein by reference.

### BACKGROUND

The present invention relates to wireless communications, and more particular, to a method and apparatus of utilizing redundant indication fields in time slots to improve accuracy of channel estimation/signal to interference plus noise ratio estimation.

Wireless communications systems are deployed to provide communication such as voice and packet data. These communications systems are based on code division multiple access (CDMA), time division multiple access (TDMA), frequency division multiple access (FDMA), or other multiple access techniques. 3rd Generation Partnership Project (3GPP) released Universal Mobile Telecommunications Systems (UMTS) standard in release 99, which is based on CDMA technology. Depending on the duplex method, there are UMTS frequency-division duplexing (UMTS FDD) and UMTS time-division duplexing (UMTS TDD) standardized versions.

In UMTS FDD system, a user equipment (UE) communicates with a Node B via physical channels. The physical channels typically consist of a layered structure of radio frames and time slots. Typically, a length of a radio frame is 10 ms and one frame consists of 15 time slots. Each time slot consists of fields containing bits. These fields include bits that carry user data or control information. Uplink physical channels include dedicated physical data channel (uplink DPDCH) and dedicated physical control channel (uplink DPCCH) and other common physical channels. Downlink physical channels include dedicated physical channel (downlink DPCH) and other common control channels. Please refer to FIG. 1, which depicts principle frame structures of an uplink dedicated physical channel and a downlink dedicated physical channel. In both of uplink/downlink dedicated physical channels, there are a pilot field, a transmit power control (TPC) field, and a transport-format combination indicator (TFCI) field included therein. The uplink DPCCH further includes feedback information (FBI) field. The pilot field consists of known pilot symbols to support channel estimation for coherent detection, the TPC field consists of TPC commands, and the TFCI field consists of bits to inform a receiver about instantaneous parameters of different transport channels multiplexed on the uplink DPDCH, and corresponds to data transmitted in a same frame.

The TPC command in the TPC field allows a command receiver to conduct power control, adjusting its transmit power. Typically, a rate of transmitting TPC command (e.g. TPC rate) to the command receiver is 1500 Hz. However, in some applications, the TPC rate may be reduced down to 750 Hz or even 500 Hz in order for reducing transmit power and the interference, and increasing the system capacity. Once the TPC rate is reduced down to 750 Hz or 500 Hz, TPC commands may be sent once every two or three time slots. As a result, TPC fields of some time slots become redundant.

### SUMMARY

With this in mind, it is one objective of the present invention to provide a method and an apparatus to utilize redundant indication fields for transmitting known symbols that can be used for estimating channel characteristics, such as channel estimation and signal to interference plus noise ratio estimation. In particular, the present invention utilizes the TPC field to transmit TPC command once every two or more time slots. The remaining TPC fields of the time slots will be filled with known symbols.

According to one exemplary embodiment, a method of utilizing same indication fields of time slots for different purposes is provided. The method comprises: transmitting an indication signal in an indication field of at least one first time slot on a dedicated physical channel (DPCH); and transmitting at least one known symbol in an indication field of at least one second time slot on the DPCH, wherein the known symbol is arranged for estimating channel characteristics.

According to one exemplary embodiment, an apparatus is provided. The apparatus comprises a transmitter and a symbol insertion unit. The transmitter is arranged to transmit at least one first time slot on a dedicated physical channel (DPCH), and transmit at least one second time slot on the DPCH, wherein an indication field of the at least one first time slot includes a indication signal, and an indication field of the at least one second time slot includes at least one known symbol. The symbol insertion unit is coupled to the transmitter and arranged to insert the at least one known symbol into the indication field of the second time slot. The known symbol is arranged for estimating channel characteristics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates principle frame structures of an uplink dedicated physical channel and a downlink dedicated physical channel.

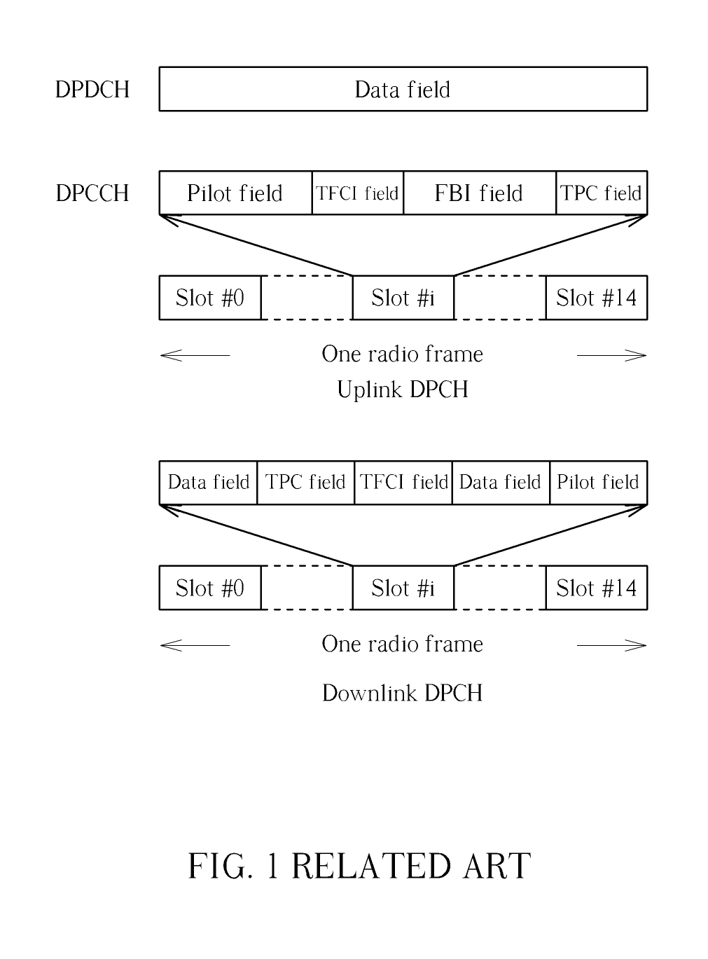

FIG. 2 illustrates a flowchart of a method according to one exemplary embodiment of the present invention.

FIG. 3 illustrates an extension of channel estimation/SINR estimation for an uplink DPCCH.

FIG. 4a and FIG. 4b illustrates an implementation regarding how to utilize TPC fields for known symbols.

FIG. 5a and FIG. 5b illustrates another implementation regarding how to utilize TPC fields for known symbols.

FIG. 6 illustrates a block diagram of an apparatus according to one exemplary embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

While embodiments of the present invention will be described hereinbelow for operation according to UMTS FDD standard, one of ordinary skill in the art will appreciate that the techniques may readily be applied to other wireless communications systems. Such alternative exemplary embodiments are contemplated to be within the scope of the present invention.

In UMTS FDD system, communications between the UE and the Node B include DPCHs. Once an uplink or downlink DPCH is established between the UE and the Node B, both of the UE and the Node B may tries to adjust the transmit power by sending a TPC command at the TPC rate of 1500 Hz to each other. Rather than 1500 Hz, The TPC rate may be reduced to improve the system capacity. When the TPC rate is reduced down, the TPC command only needs to be sent once every few time slots, thereby causing TPC fields of some time slots to be redundant. For example, when the TPC rate is reduced to 750 Hz, there will be one redundant TPC field every two time slots. Depending on the TPC rate, one of ordinary skill should be appreciated that there may be different amounts of redundant TPC fields in every few time slots, or a radio frame.

In order to effectively utilize the TPC field of every time slot at a lower TPC rate, the present invention utilizes the redundant TPC field for a different purpose. That is, transmitting known symbols in the redundant TPC fields for estimating channel characteristics.

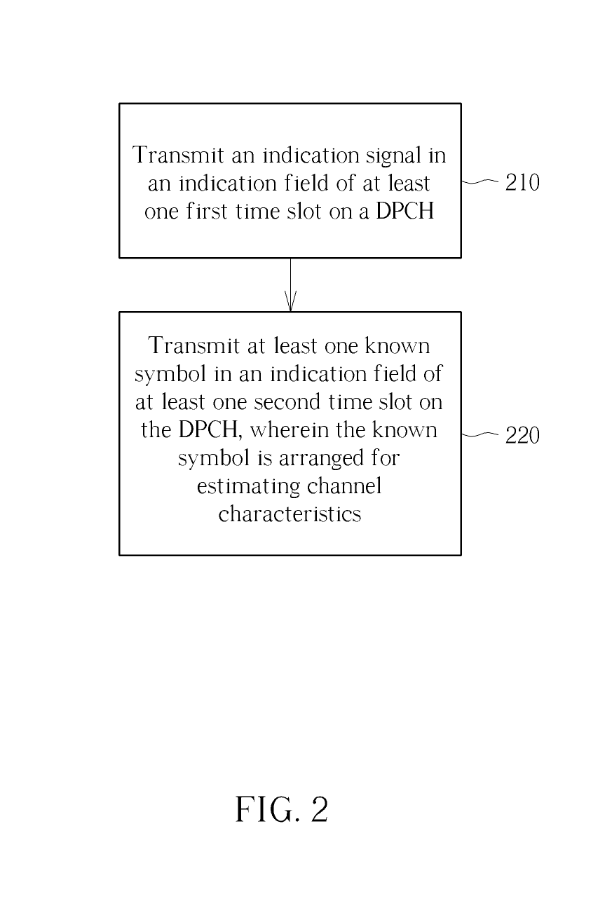

Please refer to FIG. 2, which illustrates a flowchart of a method of utilizing TPC field of time slots according to one exemplary embodiment of the present invention. At first, the flow goes to Step 210, in which an indication signal is transmitted in a power control field of at least one first time slot on a dedicated physical channel (DPCH). The indication signal could be a TPC command that is used for a command receiver to conduct power control. In addition, the DPCH could be either an uplink DPCH or a downlink DPCH.

Then, the flow goes to Step 220, in which at least one known symbol is transmitted in an indication field (e.g. TPC field) of at least one second time slot on the DPCH. The known symbol includes a known bit sequence, and arranged for estimating channel characteristics regarding the DPCH. Please note that the first time slot and the second time slot may be consecutive or not. However, the known symbols must be transmitted in a predefined occupation pattern. Before the DPCH is established between the UE and the Node B, the UE and the Node B are configured by the network based on the predefined occupation pattern. The predefined occupation pattern determines which time slot contains the TPC field having known symbols rather than TPC command. In this way, a command transmitter places known symbols in specific TPC fields, and the command receiver tells symbols in the TPC field are either a known symbol or a TPC command.

Although the above indication field is interpreted as a power control field and the indication signal is interpreted as a power control command, one of ordinary skill in the art will appreciate that it is applicable to transmit known symbols in other types of indication fields of the time slot if these indication fields are also redundant.

Advantages of transmitting known symbols for estimating channel characteristics in redundant TPC field are presented as below. On an uplink dedicated physical control channel (DPCCH), the known symbol transmitted in the TPC field can be used by the command receiver to conduct channel estimation and/or signal to interference plus noise ratio (SINR) estimation for the uplink DPCH. Channel estimation and SINR estimation can be more precise because the command receiver can refer to, not only pilot symbols in a pilot field of time slots but also the known symbol transmitted in the TPC field, to conduct channel estimation and SINR estimation. On the downlink DPCH, as the command receiver uses common pilot symbols on a common physical channel, the known symbols transmitted in the TPC fields will be used in SINR estimation.

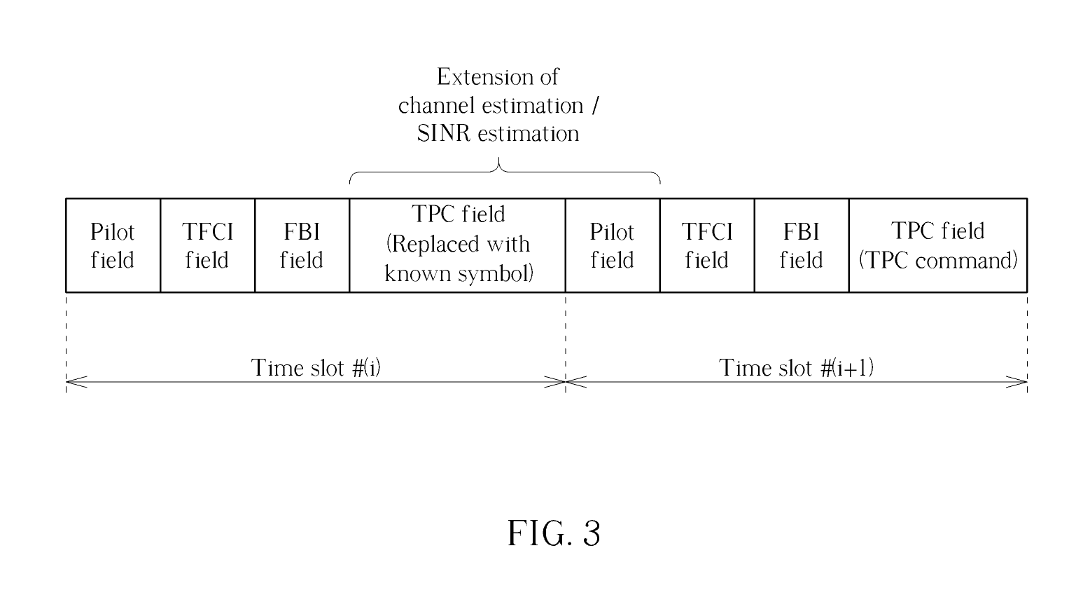

Further, on the uplink DPCCH, when one redundant TPC field of a previous time slot is used in conjunction with a pilot field of a next time slot, to transmit known symbols, the duration of channel estimation/SINR estimation is extended. In this way, the command receiver can obtain a longer known bit sequence for channel estimation/SINR estimation for the uplink DPCH. FIG. 3 illustrates an extension of the duration of channel estimation/SINR estimation. As can be seen from FIG. 3, the TPC field of time slot (i) is now assigned to transmitting known symbols. As a result, channel estimation/SINR estimation can be conducted during the TPC field of the time slot (i) and the pilot field of the time slot (i+1).

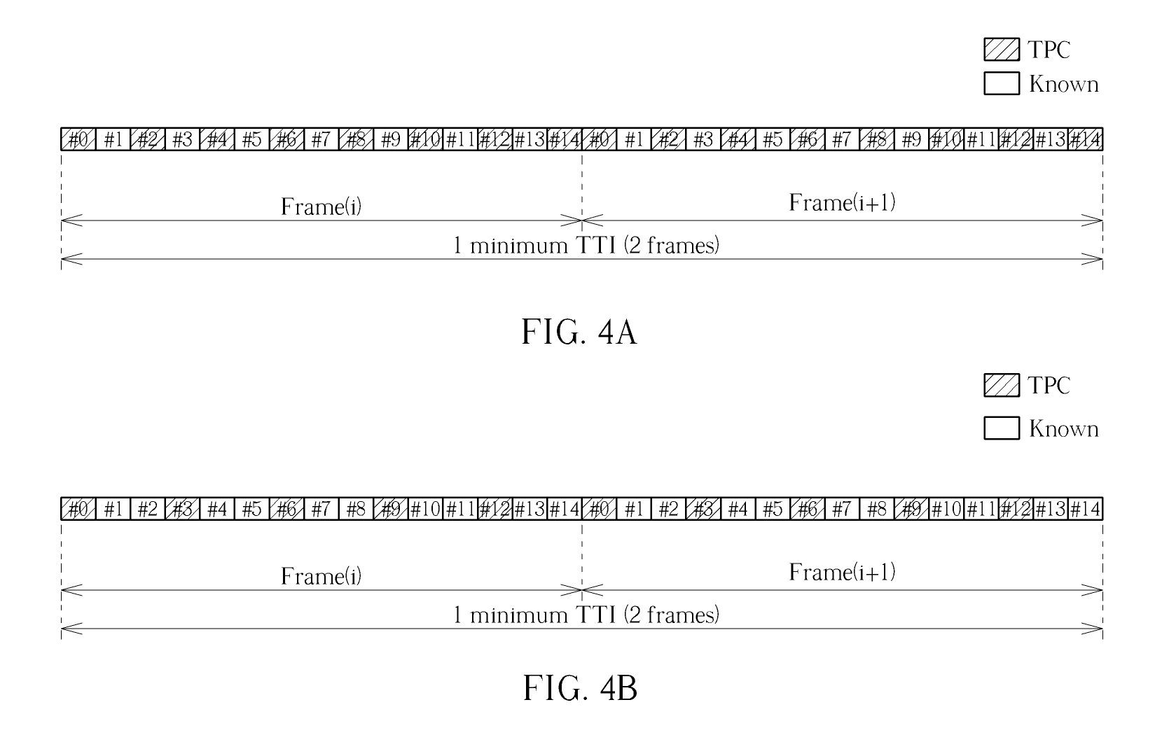

FIG. 4a and FIG. 4b illustrate possible implementations of utilization of a series of TPC fields incase of a minimum transmission time interval (TTI) being 2 frames. In FIG. 4a, as the TPC rate is reduced to 750 Hz, there is one TPC field available for transmitting known symbols every two time slots. In FIG. 4b, as the TPC rate is reduced to 500 Hz, there are two TPC fields available for transmitting known symbols every three time slots.

In some embodiments, these redundant TPC fields could be reserved for other purposes. For example, in some CDMA system, data transmission could be early terminated due to transmission redundancy. This technique allows a data receiver to attempt to decode received symbols before all symbols are received by the data receiver. If decoding is successful, the data receiver will send an acknowledgement (ACK) message to cease transmissions of remaining symbols from a data transmitter. Such technique minimizes transmission redundancy, thereby increasing system capacity. To utilize the redundant TPC field, it is possible to use the redundant TPC field to send these ACK messages to the data transmitter.

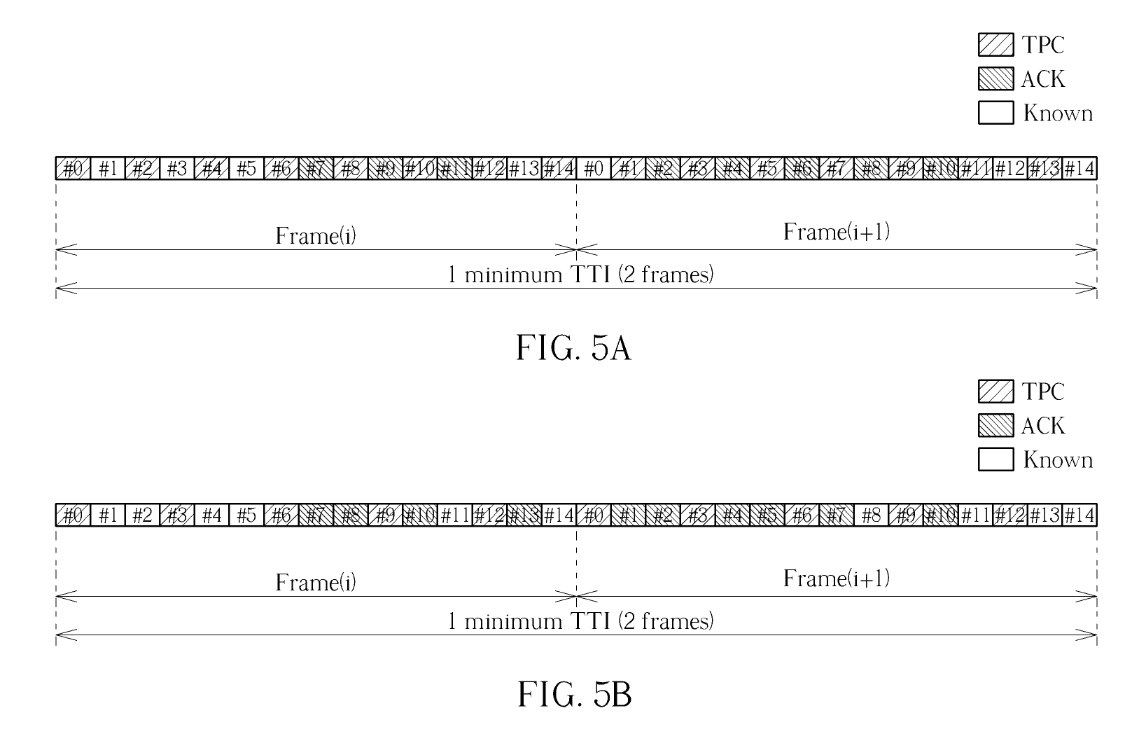

FIG. 5a illustrates an implementation that utilizes the TPC fields to transmit ACK message for ceasing transmission of symbols as well as the known symbols, while the TPC rate is reduced to 750 Hz. In such implementation, some of the redundant TPC fields are used to transmit known symbols while some of the redundant TPC fields are used to transmit ACK messages for ceasing transmission of data symbols. As early termination hardly occurs in the beginning of data transmission, the ACK messages will not be transmitted in the redundant TPC fields of first few time slots. FIG. 5b illustrates an implementation of the TPC rate being 500 Hz. In such implementation, there are more redundant TPC fields available for transmitting known symbols and ACK messages.

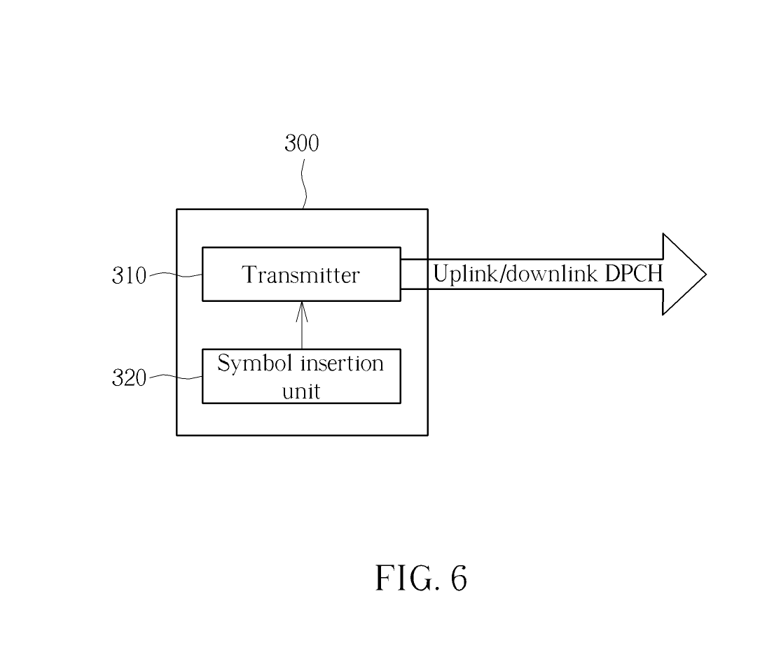

FIG. 6 illustrates a block diagram of an apparatus according to one exemplary embodiment of the present invention. The apparatus may be adopted in an UE or a Node B in a UMTS FDD system. The apparatus is able to utilize redundant TPC field due to reducing of TPC rate.

As shown in FIG. 6, the apparatus 300 includes a transmitter 310 and a symbol insertion unit 320. The transmitter 310 communicates with a receiver (not shown) via a DPCH established therebetween. The DPCH may be an uplink DPCH or a downlink DPCH. The transmitter 310 respectively transmits an indication signal and at least one known symbol in TPC fields of different time slots on the DPCH. Before the DPCH is established between the transmitter 310 and the receiver, both the transmitter 310 and the receiver are configured by the network to perform transmissions of TPC commands and known symbols based on the predefined occupation pattern. The transmitter 310 places the known symbols in specific TPC fields, respectively. In addition, according to the predefined occupation pattern, the receiver can tell which time slot contains the TPC field having known symbols and which time slot contains the TPC field having TPC commands . Once the receiver receives the time slot containing the TPC field having known symbols, the receiver performs channel estimation/SINR estimation according to received known symbol in the TPC field. The symbol insertion unit 320 is arranged to insert the known symbol into the TPC field of the time slot. In particular, once the TPC rate is reduced, the symbol insertion unit 320 determines how many time slots have TPC fields that are available for transmitting known symbols according to the TPC rate. Accordingly, the symbol insertion unit 320 inserts the known symbol into available TPC field according to the predefined occupation pattern. With the help favor of the apparatus 300, the receiver can obtain better channel estimation/SINR estimation results.

In conclusion, the present invention effectively uses indication fields of every time slot as well as improve the accuracy of channel estimation/SINR estimation.

Those of skill would further appreciate that the various illustrative logical blocks, modules, circuits, and algorithm steps described in connection with the exemplary embodiments disclosed herein maybe implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of utilizing same indication fields of time slots for different purposes, comprising:
transmitting an indication signal in an indication field of at least one first time slot on a dedicated physical channel (DPCH); and
transmitting at least one known symbol in an indication field of at least one second time slot on the DPCH, wherein the known symbol is arranged for estimating channel characteristics.

2. The method of claim 1, wherein each of the indication field of the at least one first time slot and the indication field of the at least one second time slot is a power control field.

3. The method of claim 1, wherein the indication signal is a transmit power control command.

4. The method of claim 1, wherein the indication signal is an acknowledge message that is operable for early termination of data transmission on the DPCH.

5. The method of claim 1, wherein the known symbol is used for channel estimation.

6. The method of claim 5, wherein the DPCH is an uplink DPCH.

7. The method of claim 1, wherein the known symbol is used for signal to interference plus noise ratio (SINR) estimation.

8. The method of claim 7, wherein the DPCH is a downlink DPCH or an uplink DPCH.

9. An apparatus, comprising:
a transmitter, arranged to transmit at least one first time slot on a dedicated physical channel (DPCH), and transmit at least one second time slot on the DPCH, wherein an indication field of the at least one first time slot includes a indication signal, and an indication field of the at least one second time slot includes at least one known symbol; and
a symbol insertion unit, coupled to the transmitter, arranged to insert the at least one known symbol into the indication field of the second time slot;
wherein the known symbol is arranged for estimating channel characteristics.

10. The apparatus of claim 9, wherein each of the indication field of the at least one first time slot and the indication field of the at least one second time slot is a power control field.

11. The apparatus of claim 9, wherein the indication signal is a power control command.

12. The apparatus of claim 9, wherein the indication signal is an acknowledge message that is operable for early termination of data transmission on the DPCH.

13. The apparatus of claim 9, wherein the known symbol is used in channel estimation.

14. The apparatus of claim 13, wherein the DPCH is an uplink DPCH.

15. The apparatus of claim 9, wherein the known symbol is used for signal to interference plus noise ratio (SINR) estimation.

16. The apparatus of claim 15, wherein the DPCH is a downlink DPCH or an uplink DPCH.
